(19) United States
(12) Patent Application Publication
(10) Pub. No.: US 2012/0321858 A1
(43) Pub. Date: Dec. 20, 2012

(54) MOLDINGS DESIGNED TO PREVENT FALLS

(75) Inventors: Peter Seelmann, Wien (AT); Manfred Geyer, Tribuswinkel (AT); Katharina Holy, Schwechat (AT); Gerd Hampl, Bruck an der Leitha (AT); Brigitte Zednik, Au am Leithagebirge (AT); Walter Hutterer, Ebergassing (AT)

(73) Assignee: Evonik Roehm GmbH, Darmstadt (DE)

(21) Appl. No.: 13/580,065

(22) PCT Filed: Feb. 4, 2011
(86) PCT No.: PCT/EP2011/051648

§ 371 Date: Aug. 20, 2012

(30) Foreign Application Priority Data
Mar. 4, 2010 (DE) 102010010312.8
Apr. 28, 2010 (DE) 102010028317.7

(51) Int. Cl. B32B 5/08; B29C 39/02; B29C 49/16; B29C 51/10

(52) U.S. Cl. 428/175; 264/500; 264/526; 264/279; 428/220

(57) ABSTRACT

Molding composed of metal-network-reinforced plastic in the form of a domelight, and production process for same.

The invention relates to moldings which are suitable for use as lightweight construction elements and are preferably translucent. Examples of moldings of this generic type are domelights or roof lanterns made of acrylic sheet. They are preferably used as translucent roof element. In Austria there are on average 35 accidents per year in which roof workers fall through a domelight made of transparent plastics and suffer severe injury, for example during repair of air-conditioning installations or satellite installations, or when clearing snow or carrying out maintenance, etc. From 10 to 20% of said accidents are fatal! In Germany, too, it is regrettable that every year sees fatalities caused by accidents involving falls of through domelights.

### PRIOR ART

DE 79 31 201 U1 describes rigid, one-piece moldings made of biaxially stretched plastic in the form of a sheet of a thickness at least 1 mm, the edge of which does not lie within a plane. These products are used as roof elements.

DE 93 16 382.7 U1 describes a flattened pyrimidal rooflight made of plastic comprising a plurality of flat pyramidal areas delimited by straight lines and abutting one another at slightly rounded edge areas.

U.S. Pat. No. 4,223,493 describes a roofing element made of a sandwich panel and of a solid curved panel arranged over the sandwich panel. Spacers separate the solid curved panel from the sandwich panel by from 10 mm to 40 mm.

Although all of the abovementioned moldings are used as roofing elements, they require additional safety measures in order to comply with current safety standards. Among said safety measures are:
grid structure with structural-steel grid covering the entire area within the curb
protective covering of the external side of the structure covering the entire area with grids or perforated sheet metal
barrier equipment with separate barrier points or with horizontal rails, where cables are attached to prevent personnel located on the roof from falling
grid structures covering the entire area, e.g. a grid fence around the domelight.

The safety equipment described above for roof glazing or glazing elements involving potential danger are very complicated or expensive, or fail to provide adequate safety.

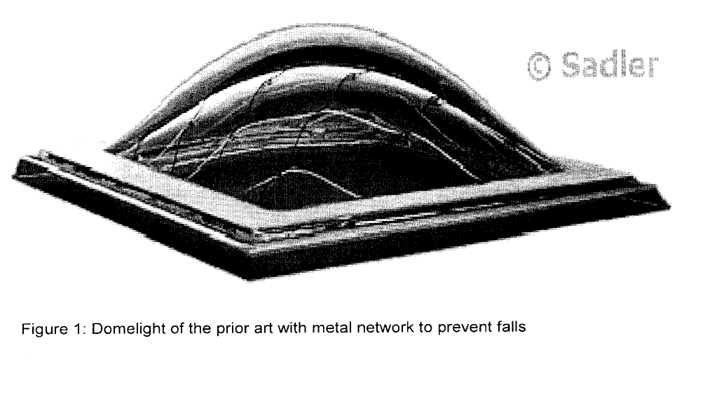

One way of avoiding additional safety measures has been realized by developing domelights which are designed to prevent falls. To this end, a wide-mesh metal network secured to a metal frame has been used (see FIG. 1). The said metal network mounted on the metal frame is secured between the external shell and the internal shell and lies between the shells without any additional fixing. The metal frame is secured by way of the screw-thread fixing of the domelight to the curb. This type of fall prevention system is marketed by way of example by Sadler in Austria.

A disadvantage of the fall prevention system described above, made of metal wires, is considered to be that the processing methods known hitherto for domelights are restricted to a biaxial filming process. The design freedom available to designers and architects is therefore greatly restricted. Another disadvantage is considered to be that the metal grid is clearly visible in the domelight (see FIG. 1).

Another factor discernible from the example of a metal network introduced between the external shell and the internal shell of the domelight is the major additional cost: An appropriate metal network structure has to be manufactured for each roof element. There is moreover also always the risk that processing or installation will not be entirely satisfactory.

EP 1 029 984 A1 describes moldings made of thermoplastic which comprise plastics filaments cast into the polymer matrix. Said moldings are used as sound-deadening partitions, where the filaments serve for avoidance of splintering in the event of an impact. This is achieved in that the filaments retain the fragments. Highly visible colored filaments are used in the sound-deadening partitions, in order to avoid problems of bird-strike. Moldings based on this principle are unsuitable for roofing systems because they are much too heavy, they cast clearly discernible shadows, and they also fail to comply with the safety requirements for roofing systems.

### OBJECT

In view of the prior art discussed above, it was therefore an object to provide moldings which can be used to produce roofing systems or barrier elements in dangerous areas and which do not have the disadvantages discussed above or have these only to a reduced extent. A specific object consisted in developing moldings which require no additional safety measures to comply with the safety requirements. Another specific object consisted in developing moldings which require no additional safety measures to comply with the safety requirements and at the same time have low weight and are easy to process, and also cast less shadow, in comparison with the known moldings.

Other objects not explicitly mentioned will be apparent from the entire context of the following examples, description, and claims.

Said objects are achieved through the moldings defined in more detail in the following description, and in the examples and claims.

Surprisingly, the inventors have discovered that it is possible to produce lightweight moldings which comply with the safety requirements for roofing systems by incorporating a suitable breakage-resistant arrangement in a specific manner into a thin polymer matrix and thus producing a molding that prevents falls.

The inventors have discovered here that it is necessary that the breakage-resistant arrangement used in the invention can separate itself from the polymer matrix in the direction of the energy of the impact, and that it has sufficient freedom of movement to absorb impact energy acting on the molding in accordance with EN 1873. The invention achieves this in that the breakage-resistant arrangement comprises filaments and/or cables and/or tapes which have been arranged along the longest and second-longest sides of the molding in such a way that they form a network or grid or fabric. “Along the longest and second-longest sides” does not mean that the filaments and/or cables and/or tapes have to have been arranged parallel to said sides. Diagonal or other arrangements are also possible. This wording is intended merely to define the plane within which the breakage-resistant arrangement lies.

In the invention it is moreover necessary to ensure that the filaments and/or cables and/or tapes have been connected securely to one another at a minimum possible number of the intersection points and preferably at no intersection point, i.e. have been arranged in such a way that they can move with respect to one another when a force acts on the molding. In other words, the number of intersection points at which the filaments or cables or tapes have been knotted with one another or adhesive-bonded or securely connected to one another by any other means should be only small, and preferably zero. The proportion of intersection points where the cables, tapes or filaments have been connected to one another is preferably only 50%, particularly preferably less than 25%, very particularly preferably less than 10%, specifically preferably less than 5%, and very specifically preferably 0%.

A feature of the breakage-resistant arrangement used in the invention is therefore, in the event of action of appropriate force on the molding, high freedom of movement, internally and in all dimensions of the molding, and the arrangement therefore differs greatly from, for example, fixed networks.

The moldings of the invention provide a wide range of design possibilities, since the breakage-resistant arrangement can be composed not only of the preferred polyamide but also of other materials such as PE, PP, polyester, etc.

The moldings of the invention can be produced either in simple shapes, e.g. as sheet, or else in two- or three-dimensionally molded form. It is therefore also possible to produce products which are complicated three-dimensional moldings, e.g. domelights. A feature of the moldings of the invention in all cases is that they have very low weight and prevent falls. This is particularly astounding in the case of three-dimensionally molded products, since a successful method has been found to compensate for the effects of the shaping process.

For the purposes of the present invention, “a two-dimensionally molded product” means moldings obtained by bending and/or angling a molding in the shape of a sheet, around an axis, uniformly or nonuniformly. This also includes the possibility of a plurality of forward and backward bending processes (e.g. corrugation) and/or angling processes around said axis. Examples of two-dimensionally molded products are found in EP 1 029 984 A1. A “three-dimensionally molded product” correspondingly means moldings obtained by bending and/or angling a molding in the shape of a sheet, around two axes, uniformly or nonuniformly (e.g. domelight). It is, of course, possible that this process involves stretching and compression of the product. However, the above definition applies when establishing whether for the purposes of the present invention a product is to be considered as having been two- or three-dimensionally molded.

The advantages of the moldings of the invention, in particular of the three-dimensionally molded products of the invention, can be summarized as follows:
In contrast to domelights in which the fall prevention system is composed of metal wires, the mounting of the moldings of the invention is not restricted to biaxial mounting, and the design freedom available to designers and architects is therefore greatly increased.
The problem of distinct visibility of the metal grid in the domelight of the prior art, with resultant visual nuisance caused by the shadowing effect of the grid, in particular when there are operators working underneath, has been minimized.
In the prior art, very great care has to be taken in securing the metal frame, e.g. screw-thread fixing to the curb, since otherwise the system is not sufficiently secure. This is not the case with the moldings of the invention.
A substantial disadvantage of the domelights of the prior art is splintering after impact on the test specimen. Although the test specimen is retained by the metal wires and cannot fall, dangerous injuries can nevertheless occur, caused by any pointed and sharp fragments of the domelight which are not securely retained. This problem, too, has been solved.
The weight of the moldings of the invention is markedly lower than that of those with metal frames.
The production process or installation process for the metal networks used hitherto involves much more complicated engineering and is much more expensive.
The moldings of the invention provide the best possible protection from the danger of injury in the event of a fall through the fractured parts of the dome, and therefore reduce the risk of accident and avoid fatalities.
Although the moldings of the invention prevent falls, they are almost completely translucent.
The moldings of the invention reliably provide high cost-effectiveness and cost saving through simplification of the production process/installation process for the fall prevention system in domelights/roof elements/glazing elements
The moldings of the invention provide a total installation solution, i.e. there is no need to carry out any additional operations for a fall prevention system, since the appropriate retention system has been integrated within the sheet
The products comply with the existing standards for fall prevention in accordance with EN 1873 class SB 450 and in accordance with GS Bau 18 of the Hauptverband der deutschen Berufsgenossenschaft
The entire safety equipment for the moldings of the invention is produced in the form of a single unit by a single producer
The fall prevention system does not impair the opening mechanism of the domelights/roof elements/glazing elements
Cleaning and maintenance are facilitated because there is no additional handling of a metal grid
By virtue of the composite produced by the polymer matrix and the integrated retention system, very little splintering of the material occurs in the event of fracture
The fall prevention system used in the invention can easily be subjected to forming processes in all directions and therefore creates very little restriction on design freedom
The moldings of the invention represent single-product solutions. Because there is no mixture of metal and plastic, they are environmentally friendly and recyclable
They provide individuality and aesthetically attractive appearance, and also unrestricted design possibilities in terms of shape, structure and color
The invention reliably provides robustness, loadbearing capability, and long life, and the acrylic sheet with its fall prevention system reliably provides many years of protection from open-air weathering and many years of UV resistance
The invention reliably provides capability for use not only in roof elements but also in many other safety devices

The moldings of the invention, preferably a sheet or a three-dimensionally molded product, in particular a roof element, a domelight or a roof lantern are preferably composed of a thermoplastic, particularly preferably of poly(meth)acrylate (PMMA) or polycarbonate (PC). They can be transparent, non-transparent, matt, glossy, or colored. They particularly preferably involve a transparent thermoplastic. The plastics can comprise appropriate additives known to the person skilled in the art, e.g. impact modifiers or fillers.

The breakage-resistant arrangement made of plastic comprises filaments and/or cables and/or tapes which as described above have been arranged two-dimensionally across the area of the molding in such a way that they form a network or grid or fabric. As likewise previously mentioned, the filaments and/or cables and/or tapes are permitted to have secure connection to one another only at some intersection points, and preferably at no intersection point. For reliable provision of still better flexibility and damping effect, it has moreover proven to be particularly advantageous if the tensile strain at break (measured in accordance with DIN EN ISO 13934) of the breakage-resistant arrangement is from 1 to 60%, particularly preferably from 10 to 60%, and very particularly preferably from 20 to 50%.

The diameter of the filaments or cables used in the invention is from 0.001 to 1.5 mm, preferably from 0.01 to 1.5 mm, particularly preferably from 0.1 to 1.3 mm, very particularly preferably from 0.5 to 1.2 mm, and specifically preferably from 0.7 to 1.2 mm. The very thin filaments with diameter less than 0.1 mm here are processed to give cables with an appropriate diameter. It is thus possible inter alia to minimize the problem of shadows cast when light passes through the material, and to reduce costs. It was moreover surprising that such small diameters sometimes actually improve the fall prevention system.

In a first specific embodiment of the present invention, the breakage-resistant arrangement used in the invention involves an arrangement of the type defined above made of polyamide with tensile strain at break (measured in accordance with DIN EN ISO 13934) of from 10 to 60%, preferably from 20 to 50%. Examples here are networks from SEFAR (e.g. NITEX 06), networks from LECO WERKE (e.g. Article No. 02/09000000/000/103), filaments from Filkemp (Produkt PA, type KJ2S, product code: MEADA 6000M) or from Monofil-Technik GmbH or from Perlon Monofil GmbH.

In a second specific embodiment, the breakage-resistant arrangement used in the invention involves an arrangement of the type defined above made of polypropylene (PP) with tensile strain at break (measured in accordance with DIN EN ISO 13934) of from 10 to 60%, preferably from 20 to 50%. Examples here are networks from SEFAR (e.g. PROPYLTEX 05), networks from LECO WERKE made of PP, and filaments from appropriate producers.

In a third specific embodiment, the breakage-resistant arrangement used in the invention involves an arrangement of the type defined above made of polyethylene (PE) with tensile strain at break (measured in accordance with DIN EN ISO 13934) of from 1 to 50%, preferably from 10 to 40%. Examples here are networks from LECO WERKE made of PE.

In a fourth specific embodiment, the breakage-resistant arrangement used in the invention involves an arrangement of the type defined above made of polyesters with tensile strain at break (measured in accordance with DIN EN ISO 13934) of from 10 to 60%, preferably from 20 to 50%. Examples here are meshes from Schilgen (e.g. Monofil 161800).

As explained above, the breakage-resistant arrangement comprises filaments and/or cables and/or tapes. In the case of cables, the invention involves products which have been processed from filaments to give cables by known processes. In the case of tapes, those involved are by way of example extrudates made of the above-mentioned plastics and having a shape other than round.

As also indicated above, the filaments and/or cables and/or tapes in the invention have been arranged two-dimensionally across the area of the molding in such a way that they form a network or grid or fabric, where they have secure connection to one another only at some of the intersection points, and preferably at no intersection point.

This can be achieved by way of example by tensioning filaments and/or cables and/or tapes of the invention in such a way that they form a grid which is then encapsulated by the polymer matrix. However, it is also possible to process the filaments and/or cables and/or tapes by known processes to give an appropriately coarse-mesh fabric and then to embed this into the polymer matrix.

In the case of networks, care has to be taken that these do not involve networks which, at the intersection points, have adhesive bonding or knotting, but that the materials are instead by way of example meshes in which the individual filaments can move with respect to one another at the intersection points.

The arrangement of the filaments and/or cables and/or tapes has to be such that the distance between them is in each case from 1 to 25 mm, preferably from 2 to 15 mm, and particularly preferably from 5 to 15 mm. The resultant meshes do not have to be square. Rectangular meshes or meshes of other shapes are equally possible. The separations in the respective axes can vary, and the separations along an axis can also vary. This provides a correspondingly high degree of design freedom. The small separations contribute substantially to compliance with safety requirements. The mesh widths or the distances between filaments can be adjusted appropriately for the size and the requirements of the molding.

It is preferable that the breakage-resistant arrangement is introduced into the polymer matrix by directly producing a molding in the form of a polymer sheet with embedded breakage-resistant arrangement. This molding can then be subjected to a forming process to give moldings of complex shape. In a preferred process, the molding here is brought to a temperature which is preferably from 160 to 200° C. by appropriate heating devices, e.g. an IR source, convection oven, or appropriate hotplates. The molding thus heated is then converted to the desired two- or three-dimensional shape, preferably by blowmolding or by a vacuum thermoforming process. The molding is then cooled and removed from the mold. The heat sources, in particular the IR sources, can be used on one side or on two sides. It is, of course, also possible to use any other forming processes known to the person skilled in the art.

The polymer sheet is preferably produced by a casting process.

The moldings of the invention have relatively thin walls and they therefore have low weight and are inexpensive. Their thickness at the thickest point is therefore preferably from 1 to 15 mm, particularly preferably from 2 to 12 mm, and very particularly preferably from 3 to 10 mm.

In order to achieve a still further improvement in safety properties, ratio of thickness of the molding of the invention at the thickest point to diameter of the filaments/cables and/or thickness of the tapes is preferably in the range from 20 to 1 to 5 to 1, preferably from 15 to 1 to 5 to 1.

Furthermore, the moldings of the invention have provided the first success in producing three-dimensionally molded products which provide fall prevention and which have a small radius together with low thickness. The ratio of rise height to the thickness of the molding at the thickest point is in the region of 150 to 1, preferably 100 to 1, particularly preferably 75 to 1.

The (meth)acrylates

(Meth)acrylates are a particularly preferred group of monomers. The expression (meth)acrylates comprises methacrylates and acrylates, and also mixtures of the two. These are well-known monomers. Among them are inter alia (meth)acrylates which derive from saturated alcohols, e.g. methyl(meth)acrylate, ethyl(meth)acrylate, propyl(meth)acrylate, isopropyl(meth)acrylate, n-butyl(meth)acrylate, tert-butyl(meth)acrylate, butoxymethyl(meth)acrylate, pentyl(meth)acrylate, hexyl(meth)acrylate, heptyl(meth)acrylate, octyl(meth)acrylate, isooctyl(meth)acrylate, isodecyl(meth)acrylate, tetrahydrofurfuryl(meth)acrylate, cyclohexyl(meth)acrylate, and 2-ethylhexyl(meth)acrylate; (meth)acrylates which derive from unsaturated alcohols, e.g. oleyl(meth)acrylate, 2-propynyl(meth)acrylate, allyl(meth)acrylate, vinyl(meth)acrylate; aryl(meth)acrylates, e.g. benzyl(meth)acrylate, or phenyl(meth)acrylate, where each of the aryl moieties can be unsubstituted or can have up to four substituents; cycloalkyl(meth)acrylates, e.g. 3-vinylcyclohexyl(meth)acrylate, bornyl(meth)acrylate; isobornyl(meth)acrylate, hydroxylalkyl(meth)acrylates, e.g. 3-hydroxypropyl(meth)acrylate, 3,4-dihydroxybutyl(meth)acrylate, 2-hydroxyethyl(meth)acrylate, 2-hydroxypropyl(meth)acrylate; glycol di(meth)acrylates, e.g. 1,4-butanediol (meth)acrylate, (meth)acrylates of ether alcohols, e.g. tetrahydrofurfuryl (meth)acrylate, vinyloxyethoxyethyl(meth)acrylate; amides and nitriles of (meth)acrylic acid, e.g. N-(3-dimethylaminopropyl) (meth)acrylamide, N-(diethylphosphono) (meth)acrylamide, 1-methacryloylamido-2-methyl-2-propanol; sulfur-containing methacrylates, e.g. ethylsulfinylethyl(meth)acrylate, 4-thiocyanatobutyl(meth)acrylate, ethylsulfonylethyl(meth)acrylate, thiocyanatomethyl(meth)acrylate, methylsulfinylmethyl(meth)acrylate, bis((meth)acryloyloxyethyl) sulfide; polyfunctional (meth)acrylates, e.g. trimethylolpropane tri(meth)acrylate. These monomers can be used individually or in the form of a mixture. Preference is particularly given here to mixtures which comprise methacrylates and acrylates.

### The Polycarbonates

The polycarbonates are other particularly preferred monomers. Polycarbonates are known to persons skilled in the art. Polycarbonates can formally be regarded as polyesters derived from carbonic acid and from aliphatic or aromatic dihydroxy compounds. They are readily obtainable through reaction of diglycols or bisphenols with phosgene or with carbonic diesters in polycondensation or, respectively, transesterification reactions.

Preference is given here to polycarbonates which derive from bisphenols. Among these bisphenols are in particular 2,2-bis(4-hydroxyphenyl)propane (bisphenol A), 2,2-bis(4-hydroxyphenyl)butane (bisphenol B), 1,1-bis(4-hydroxyphenyl)cyclohexane (bisphenol C), 2,2′-methylenediphenol (bisphenol F), 2,2-bis(3,5-dibromo-4-hydroxyphenyl)propane (tetrabromobisphenol A), and 2,2-bis(3,5-dimethyl-4-hydroxyphenyl)propane (tetramethylbisphenol A).

Aromatic polycarbonates of this type are usually produced through interfacial polycondensation or transesterification, and details can be found here in Encycl. Polym. Sci. Engng. 11, 648-718, or in the article on “Polycarbonates” in Ullmann's Encyclopedia of Industrial Chemistry, 7^{th} edition (2009).

Interfacial polycondensation emulsifies the bisphenols in the form of aqueous, alkaline solution in inert organic solvents, e.g. methylene chloride, chlorobenzene, or tetrahydrofuran, and reacts them in a staged reaction with phosgene. Catalysts used comprise amines, and in the case of sterically hindered bisphenols also phase-transfer catalysts. The resultant polymers are soluble in the organic solvents used. The properties of the polymers can be varied widely by way of the selection of the bisphenols. If different bisphenols are used simultaneously, it is also possible to construct block polymers in multistage polycondensation reactions. The polycarbonates are marketed by way of example by Bayer MaterialScience with trademark MAKROLON®, or by Sabic with trademark LEXAN®.

The polycarbonates provide an amorphous thermoplastic molding composition and can be processed by any of the processes usually used for thermoplastics, e.g. injection molding or extrusion. The processing temperatures are about 280 degrees Celsius to 320 degrees Celsius in the case of injection molding and between about 240 degrees Celsius and 280 degrees Celsius in the case of extrusion. Before the molding is processed, its residual moisture level has to be brought below 0.01% by weight by drying.

The moldings of the invention can, as indicated above, be produced by casting the breakage-resistant arrangement made of plastic into the plastic of the matrix material.

It is preferable that the breakage-resistant arrangement is inserted into a region defined by the center ±50%, preferably ±25%, particularly preferably ±10%, very particularly preferably ±5%, based on the thickness of the molding at the respective point of measurement.

In an alternative embodiment, the breakage-resistant arrangement is inserted 1 mm below the exterior surface of the molding of the invention.

In order to provide reliable correct positioning of the breakage-resistant arrangement made of plastic, spacers can be produced and incorporated, preferably with tolerance +/−0.1 mm.

The moldings of the invention have the specific advantage that the two- or three-dimensional forming process can be applied when the breakage-resistant arrangement has already been cast into the material, and at the same time fall prevention can be reliably ensured.

The moldings of the invention preferably involve roof elements, particularly preferably domelights. The moldings of the invention can also, however, be used as barrier elements in dangerous areas, e.g. as balcony cladding, banister cladding (illuminated or not illuminated), ski-lift fall prevention system, façade panels with network, roofing elements, partitions for buses, tractor glazing, machine protection, general protective covering for swimming pools, cladding of emergency-telephone pillars on motorways, construction-site safety systems, stadium safety barriers, corrugated roofs, safety roof glazing, carports, cabin glazing, shipboard safety glazing, pedestrian bridges, safety cabins for window cleaners, machinery glazing, or robot-manipulation cells.

Test Methods:

Fall prevention is tested in accordance with the standard EN 1873 6.4.2.2.1. Said test serves for assessment of the performance of a molding in a laboratory environment, in the event of an impact from a spheroconical sack weighing 50 kg, falling from a prescribed height of from 60 cm to 240 cm. Any aperture resulting from the impact must be sufficiently small to prevent a test sphere of diameter >300 mm from falling through it. No hole of diameter >300 mm in the domelight is therefore permitted to result from the test.

The examples below serve for further explanation of the present invention, but in no way restrict the same.

### EXAMPLES

### Example 1

### Production of a Plexiglas Sheet of the Invention with Fall Prevention System by the Water-Bath Process

### a) General Description of Process

The water-bath process produces cast acrylic sheet. The casting process here takes place between 2 glass sheets forming a mold. First, the mold is sealed with a PVC (or similar) sealing strip, and is fixed by clamps. A prepolymer or MMA (batch) is then charged to said mold. The batch can include additions usually used for the polymerization process. The polymerization process takes place in a water bath or in a convection oven. In the case of the polymerization process in the water bath, the process is concluded in an oven for post-polymerization. In the convection oven, the entire procedure proceeds by way of a controlled sequence.

### b) Detailed Description of Process

### b.a) Mold Construction

### b.a.a) With a Network as Breakage-Resistant Arrangement

The sealing strip is applied to the lower glass sheet. The network for the fall prevention system is then placed on the glass sheet and fixed in such a way that it assumes the desired position in the finished sheet. The upper glass sheet is positioned onto the lower glass sheet, and clamps are used to seal the mold.

### b.a.b) With Polyamide Filaments as Breakage-Resistant Arrangement

The sealing strip is applied to the lower glass sheet. The polyamide filaments, which have been applied in advance to battens with precisely defined separation, are then stretched over the glass plate by means of the battens and fixed at the edge of the glass. The mold is closed by the upper glass plate and fixed by a ram. The polyamide filaments are cut from the battens at the edge of the glass, and the battens are withdrawn from the glass plates. Clamps are used to fix the mold.

### c.) Charging of Material

A lifting cylinder and suckers are used to pull the mold open at one side, and the batch is charged to the mold while the latter is in an inclined position. Because there are no restrictions on the construction process for the mold, the casting process is capable of infinite variation. The construction process for the mold is a manual activity. No automation is involved at this point, and the construction process is therefore flexible. The nature and shape of the product to be cast is limited only by the size of the glass plate.

### Example 2

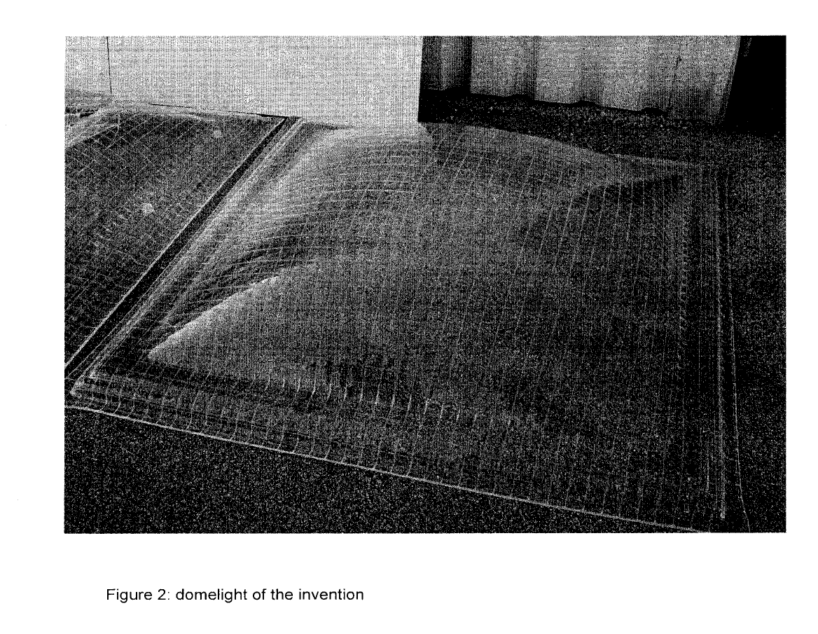

A PMMA sheet with fall prevention system made of a PA network with filament diameter 0.9 mm and with mesh width 5 mm composed of Sefar Nitex 06 was produced as in example 1. This was then used as follows to manufacture a domelight of thickness 4 mm: the sheet was heated on one side to 180° C. by using an IR source, clamped in a clamping frame, and blown to a rise height of 30 cm. Once the dome had cooled, it was removed from the mold and prepared for impact testing in accordance with EN 1873 (see FIG. 2).

A breakage test in accordance with the abovementioned standard EN 1873 gave a very positive result. Breakage resistance was reliably ensured even at a low temperature of −20° C.

The domelight here was subjected to 3 fall tests from various heights: 0.6 m, 1.2 m and 1.5 m.

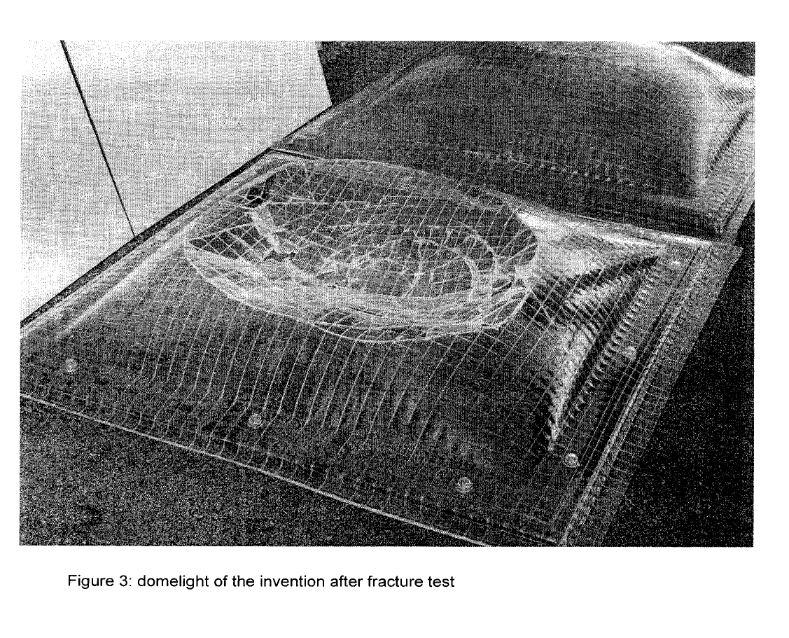

Although the first fall test was sufficient to cause breakage of the dome, even the subsequent fall tests were not sufficient to penetrate the dome (see FIG. 3).

1-14. (canceled)

15. A molding, which is a panel or a three-dimensionally molded product comprising a thermoplastic matrix comprising a breakage-resistant arrangement, which is embedded in the matrix and comprises plastic wherein:
the breakage-resistant arrangement comprises filaments and/or cables and/or tapes which are arranged two-dimensionally along a longest and a second-longest side of the molding, thereby forming a network, grid, or fabric;
a distance between the filaments and/or cables and/or tapes is in each case from 1 to 25 mm;
a diameter of the filaments/cables or a thickness of the tapes is from 0.1 to 1.5 mm; and
the filaments and/or cables and/or tapes are connected securely to one another only at some of intersection points such that they can move with respect to one another when a force acts on the molding, and
wherein a thickness of the molding is from 1 to 15 mm, and the molding is designed to prevent falls, based on the requirements in 6.4.2.2.3 of EN1873 standard.

16. The molding of claim 15, which is a transparent or non-transparent, colored or uncolored sheet.

17. The molding of claim 15, which is a transparent or non-transparent, colored or uncolored molding that has been subjected to a two- or three-dimensional forming process.

18. The molding of claim 17, wherein a ratio of rise height to a thickness of the molding at its thickest point is in the region of 150 to 1.

19. The molding of claim 17, in the form of a roof element.

20. The molding of claim 15, wherein the breakage-resistant arrangement comprises a polyamide, PP, PE, or a polyester.

21. The molding of claim 15, wherein a ratio of thickness of the molding at its thickest point to a diameter of the filaments/cables is in the range from 20 to 1 to 5 to 1.

22. The molding of claim 15, wherein a tensile strain at break, measured in accordance with DIN EN ISO 13934, of the breakage-resistant arrangement is from 1 to 60%.

23. The molding of claim 15, wherein the thermoplastic is a (meth)acrylate or a polycarbonate.

24. A process for producing the molding of claim 15, the process comprising:
(I) casting the breakage-resistant arrangement into the thermoplastic to obtain a sheet or a two- or three-dimensionally molded product comprising the breakage-resistant arrangement.

25. The process of claim 24, wherein a sheet is obtained in the casting, and the process further comprises:
(II) molding a two-dimensionally or three-dimensionally molded product from the sheet comprising the breakage-resistant arrangement.

26. The process of claim 25, wherein the molding (II) comprises:
heating the sheet to a temperature from 160 to 200° C.;
blowmolding or vacuum thermoforming the sheet, to obtain a two- or three-dimensional shape; and subsequently,
cooling and removing the two- or three-dimensional shape from a mold.

27. The process of claim 24, wherein the position of the breakage-resistant arrangement is fixed with spacers.

28. The molding of claim 15, in the form of a balcony cladding, a banister cladding (illuminated or not illuminated), a ski-lift fall prevention system, a facade panel with a network, a roofing element, a bus partition, a tractor glazing, a protective covering, a cladding of an emergency-telephone pillar, a construction-site safety system, a stadium safety barrier, a corrugated roof, a safety roof glazing, a carport, a cabin glazing, a shipboard safety glazing, a pedestrian bridge, a safety cabin, a machinery glazing, or a robot-manipulation cell.

29. The molding as claimed in claim 17, wherein a ratio of rise height to a thickness of the molding at its thickest point is in the region of 100 to 1.

30. The molding as claimed in claim 17, wherein a ratio of rise height to a thickness of the molding at its thickest point is in the region of 75 to 1.

31. The molding of claim 17, wherein the roof element is a domelight or a roof lantern.

32. The molding of claim 15, wherein a ratio of thickness of the molding at its thickest point to a diameter of the filaments/cables is in the range from 15 to 1 to 5 to 1.

33. The molding of claim 15, wherein a tensile strain at break, measured in accordance with DIN EN ISO 13934, of the breakage-resistant arrangement is from 10 to 60%.

34. The molding of claim 15, wherein a tensile strain at break, measured in accordance with DIN EN ISO 13934, of the breakage-resistant arrangement is from 20 to 50%.
